(19) United States
(12) Patent Application Publication
(10) Pub. No.: US 2005/0211090 A1
(43) Pub. Date: Sep. 29, 2005

(54) Method for achieving ultra-low emission limits in VOC control

(76) Inventor: Matthew Lee McCullough, Laguna Beach, CA (US)

Correspondence Address: MATTHEW L. McCULLOUGH, #103, 355 N. SHERIDAN ST., CORONA, CA, 92880, US

(21) Appl. No.: 10/649,016

(22) Filed: Aug. 25, 2003

(51) Int. Cl. B01D 53/02

(52) U.S. Cl. 95/92; 95/148

(57) ABSTRACT

The present invention relates to adsorption and regeneration of adsorbent media for air pollution control, volatile organic compound (VOC) control, hazardous air pollutant (HAP) control, toxic air contaminant (TAC) control, and solvent recovery. The present invention is an improved device for removing VOCs/HAPs/TACs from high volume air streams to ultra-low levels using synthetic polymeric adsorbents. The invention is embodied in a HAP adsorption section, a regeneration section, and a chemical destruction or recovery section. In order to recover HAPs from low concentration air streams, multiple adsorption (concentration) steps may be necessary. Adsorption is typically accomplished with a multi-tray fluidized bed operating in the moving bed to fully fluidized regime. The regeneration section has either a long, multi-stage regeneration column with a high number of stages relative to the number of theoretical desorption stages required or a recirculating fluidized bed with a high make-up air to volume ratio. Destruction can be carried out through a thermal or catalytic oxidizer or the regeneration air stream can be concentrated into fixed-bed carbon vessels.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION—FIELD OF THE INVENTION

The present invention relates to adsorption and regeneration of adsorbent media for air pollution control, volatile organic compound (VOC) control hazardous air pollutant (HAP) control, toxic air contaminant (TAC) control, and solvent recovery. The present invention is an improved device for removing VOCs/HAPs/TACs from high volume air streams to ultra-low levels using synthetic polymeric adsorbents.

### BACKGROUND OF INVENTION

Environmental laws relating to the emission of solvents have continued to tighten over the years as more and more research has confirmed the adverse health effects of even small doses of some volatile organic compounds (VOCs), hazardous air pollutants (HAPs), or toxic air contaminants (TACs [collectively referred to as HAPs for convenience]). In some localities, emission limits have been lowered to less than 0.005 parts per million by volume (ppmv) of some HAPs. Some compounds, namely dioxins and furans, may have emission limits significantly lower. This area of emission control has traditionally been considered infeasible because of the trivial amount and is poorly understood by many practicing in the field of air pollution control. Indeed, many regulators have a limited understanding of traditional emission control systems operating in this regime. Equipment vendors will guarantee only about 10 ppmv on regenerative adsorption equipment and most adsorption models are limited to this regime¹.
¹ Example: Carl L. Yaws et al., as cited in Chemical Properties Handbook, McGraw Hill, New York, 1999.

HAP control can be accomplished using a variety of methods: thermal or catalytic oxidation, condensation, or adsorption. In general, oxidation is applied to air streams with lower flow rates because of operating costs. Moreover, oxidation of some HAPs requires acid gas scrubbing which further increases costs. Condensation is limited in efficiency to higher concentration air streams and certainly cannot meet stringent emission limits for most HAPs.

This invention applied to adsorption—specifically physisorption, which involves van der Waals forces, and not chemisorption, which involves chemical bonding and often dissociation. Physisorption processes are regenerable processes whereas the latter generally destroys the capacity of adsorbent. Adsorption is best applied to high flow air streams with moderate to low HAP content. Adsorption is the most common solution applied to high-flow, humid air streams with stringent emission limits. In these cases, the typical solution is to use a single-use adsorption bed of granular activated carbon (GAC). Once the GAC is spent, it is disposed of in accordance with hazardous waste control laws.

The loading of the adsorbent (the mass of HAP the sorbent will sorb per unit mass [eg. Grams HAP per gram of GAC]) at saturation is proportional to the concentration in the inlet stream (see FIG. 1). If the inlet stream concentration is very low, the expected loading of the adsorbent is quite low. Also, the length of the mass transfer zone (MTZ)—the volume of the adsorption bed where HAP removal is occurring—is inversely proportional to the inlet concentration. (see FIG. 2) Thus, with stringent emission limits a large adsorption bed is required to comply and to provide a unit with adequate bed life. Another issues with traditional GAC is the lack of affinity for certain compounds such as 1,2-dichloroehtane (1,2-DCA), that can be quite toxic and are poorly adsorbed onto GAC relatively unaffected. Moreover, GACs sensitivity to humidity requires air stream heaters to be utilized and results in significant operating costs for heat alone.

Inventor's initial research into this invention began when servicing and maintaining facilities with low emission limits. A typical application is control of VOCs from water-purification equipment. In this type of application, an air stripper is used to remove VOCs from water. The humid, high volume, VOC-laden air stream is directed through fixed-beds of GAC and then vented to atmosphere. Traditional GAC systems may last less than a few days for some contaminants (see FIG. 3) and require heaters as discussed resulting in poor operating economics. The inventor began to evaluate different types of synthetic adsorbents and found that synthetic polymeric adsorbents (generally styrenic polymers) offered significant promise for a number of reasons:
Polymeric adsorbents can have a high capacity for organic molecules. Some polymeric adsorbents have as much or greater adsorption capacity than carbon under typical field conditions.
Polymeric adsorbents can have an extremely high affinity for some organic compounds that are poorly adsorbed onto GAC. For example, 1,2-DCA has been shown to be completely adsorbed in some applications.
Polymer adsorbents can be hydrophobic. The adsorbent can be treated so that it adsorbs no more than 4 percent of water by weight. Carbon can adsorb 40 percent of water by weight or more. This has several advantages First, water displaces adsorption sites make the adsorbent less efficient. Second, water is recovered during regeneration creating a waste that must be disposed of. Third, high humidity levels require pre-treatment of vapor streams when activated carbon is used (see FIG. 4).
Polymer adsorbents require less residence time—as short as 20-100 ms whereas carbon can require four seconds or more of residence time. This translates into less adsorbent, less pressure drop, and a smaller footprint for equipment.
Polymer adsorbents have greater crush strength and will thus last longer.
Polymer adsorbents are engineered to readily desorb and thus retain their adsorption properties whereas carbon tends to become less efficient over time because of incomplete regeneration.

The inventor tested various resins in a humid (90 percent relative humidity) vapor stream consisting of approximately 0.100 ppmv (100 ppbv) trichloroethylene (ICE) and 0.025 ppmv (25 ppbv) perchloroethylene (PCE). For adsorption experiments, the inventor utilized ½-internal diameter borosilicate glass columns packed three-inches of resin. Each end of the tube was packed with stainless-steel wire wool to contain the resin. The test bed consisted of five columns in series. The columns were connected using a food-grade polyethylene-lined ethyl-vinyl-acetate (EVA) tubing. Tubing was connected using barbed fittings. The resin was obtained from The Dow Chemical Company and consisted of both V503 and V493 resins. Flow through the column was controlled using a flow meter equipped with a needle valve. The flow was controlled to provide a superficial velocity of 100 feet per minute and a corresponding residence time of 0.050 seconds per inch of resin. The inlet air was collected from the air exhaust of the an air stripper and drawn through the column with a vacuum pump. Samples were drawn by inserting the needle of a gas-tight syringe through the flexible tubing and withdrawing the syringe cylinder. The hole in the tubing was then sealed with high temperature Teflon tape. (see FIG. 5).

For desorption experiments, the inventor utilized one-inch diameter, six-inch long stainless steel pipes. The pipe was then lined with a layer of borosilicate glass beads, followed by a layer of stainless steel wool, followed by a piece of wire cloth to contain the resin. Saturated resin was placed in the pipe and then another layer of steel wool was placed in the top of the pipe to contain any elutriated resin. The pipe was then connected to the outlet of a variable power heat gun with high-temperature tubing. A compression fitting was connected to the top of the pipe and the fitting was connected first to a heat exchanger to cool the exhaust gas and then to a flow meter. The flow meter was connected to a ball valve which was in turn connected to the inlet port of an air pump. Flow through the apparatus was controlled by opening and closing the ball valve. Flow through the apparatus was nominally set at 100 feet per minute. Temperature was controlled using the variable power potentiometer on the heat gun. Desorption temperature was monitored using a standard thermocouple and handheld digital readout from Omega Instruments. Samples were drawn by inserting the needle of a gas-tight syringe through the flexible tubing and withdrawing the syringe cylinder. The hole in the tubing was then sealed with high temperature Teflon tape. (see FIG. 6).

To evaluate the effectiveness of the cleaned resin, the resin was placed in a 100-milliliter vial and sealed with a lid with a Teflon septum. The vial was then heated to 120° C. and allowed to equilibrate for 5 minutes. A sample of the headspace gas was withdrawn using a gas-tight syringe and analyzed. This method provides a worst-case analysis of the residual HAPs in the resin because of the fixed head space.

The off-gas samples collected during the test were analyzed by three increasingly sensitive analytical methods:
A field gas chromatograph with dual photo-ionization detectors (PIDs) and designed for parts-per-trillion concentrations. Samples were gathered directly into 10-milliliter gas-tight syringes.
A California-certified mobile laboratory utilizing a modified USEPA Method TO-14 (gas chromatography/mass spectrometery [GC/MS]). Samples were gathered directly into 10-milliliter gas-tight syringes.
A California-certified fixed laboratory utilizing USEPA Method TO-14 (gas chromatography/mass spectrometery [GC/MS]). Samples were gathered into evacuated stainless steel Summa-canisters with a 30-minute regulator (typical method resolution of <1 ppbv)

The inventor successfully demonstrated that ultra-low concentration HAP adsorption is feasible, economical, and reversible utilizing synthetic adsorbents:
The inventor was able to develop an economical adsorption curve for the HAPs as discussed above.
The inventor was able to regenerate the resin completely. No residual HAPs were detected in resin that had been through two desorption/adsorption cycles.
The “raw” resins (direct from the manufacturer) were found to contain a significant quantity of VOCs (mainly alcohols, esters, and dichloroethene). These VOCs were removed by cleaning the resin prior to adsorption. Without this cleaning step, the resin does not have economical adsorption capacity at ultra-low concentrations.
No chemicals were detected in the headspace of the clean resin used as a control. We thus demonstrated the ability to dean the resin to levels below the laboratory detection limit (<10 ppbv). This was true even for resin that had undergone adsorption cycles as described above.

Data are shown in FIGS. 7, 8, and 9. Please note the ‘CXX’ initials prior to each sample indicate the number of cycles the resin has been through. The resin was initially cleaned and then placed into the adsorption cycle. Once the resin was estimated to be saturated, the resin was desorbed. This would complete one cycle. Resin in the first adsorption cycle would be referred to as ‘C1’ Resin at the completion of the first desorption cycle would be referred to as ‘C1.’ The resin is then placed back into adsorption and the notation is ‘C2.’

The inventor obtained similar results for Dow's V503 resin. Moreover, the inventor was able to successfully regenerate V503 resin that had been exposed to 3,000 ppmv of PCE to a non-detect headspace reading and then use this resin to completely adsorb a 90 ppbv TCE inlet stream.

A key consideration is the “working capacity” of the adsorbed resin—i.e. the difference between the full adsorption isotherm of virgin adsorbent and the adsorption isotherm of regenerated adsorbent. Adsorbents such as GAC and resins are porous. This porosity provides for the high surface area where the adsorption sites are located. The pores of an adsorbent are classified into macro-pores and micro-pores. Regenerated GAC is documented to lose up to 50 percent of adsorption capacity over virgin material. This is thought to be caused by molecules of solvent being tightly bound in micro-pores. In the case of GAC, VOCs can only be removed from these micro-pores by pyrolysis, which would destroy the VOC but also may alter the properties of the GAC.

In our experience, there is no measurable difference between the working capacity of virgin and regenerated resin over time (see FIG. 10 [Note: This data was obtained using density measurements Regenerated resin has a slight static charge which manifests as a slightly lower density, hence the regenerated capacity is measured as greater than 1). This has been documented over multiple regeneration cycles by others for synthetic resins used in liquid absorption² (see FIG. 11) and is consistent with data provided by Dow Chemical³. Nevertheless, our results are for higher concentration air streams and using measurement techniques that would not be sensitive enough for the influent concentrations discussed here.
²Y. Cohen, “Polymeric Resins for VOC Removal from Aqueous Systems,” EPA VOC Recovery Seminar, Sep. 16-17, 1998.

³ Verbal communication with Dr. Robert Goltz, Dow Chemical, Oct. 6, 2002.

### SUMMARY OF THE INVENTION

The general purpose of the present invention is for control of HAPs for air pollution control purposes. The invention is embodied in a HAP adsorption section, a regeneration section, and a chemical destruction or recovery section. In order to recover HAPs from low concentration air streams, multiple adsorption (concentration) steps may be necessary. Adsorption is typically accomplished with a multi-tray fluidized bed operating in the moving bed to fully fluidized regime. The regeneration section has a either a long, multi-stage regeneration column with a high number of stages relative to the number of theoretical desorption stages required or a recirculating fluidized bed with a high make-up air to volume ratio. Destruction can be carried out through a thermal or catalytic oxidizer or the regeneration air stream can be concentrated into fixed-bed carbon vessels.

### BACKGROUND OF THE INVENTION—PRIOR ART

This is a relatively unexplored area of emission control primarily because in most localities, no control was required of HAP concentrations as low as those in the typical application discussed here. Currently, there are only a few regulatory environments where HAP control is as stringent as that required here. A number of providers have used synthetic adsorbents including Kureha Chemical Industries of Tokyo, Japan, Chematur of Sweden (since bought by American Purification, Inc. of Newport Beach, Calif.), and various manufacturers of granular activated carbon equipment. Also, various parties have utilized synthetic media for VOC adsorption. A significant variation here is the focus and application to the ultra-low concentration regime and the on-going need for efficient and economical operation. The benefit of being able to treat ultra-low concentrations is the ability to design economical and efficient equipment that can meet stringent emission limits regardless of inlet concentration.

Various processes have been suggested for treating VOC-laden gas streams. For example, U.S. Pat. No. 5,772,734 describes removal of VOCs from “Low-Concentration” gas streams using a combination of scrubbing, stripping, and membrane adsorption processes; however, the author defines the typical “low-concentration” case as 2,900 ppm methylene chlorine. U.S. Pat. Nos. 5,676,738 and 5,904,750 describe the removal of VOC using fluidized or moving beds except they specify the use of pyrolized adsorbent. Pyrolized adsorbent is quite effective at adsorption but can be difficult to regenerate effectively at the low concentrations discussed here. Moreover, these patents focus quite heavily on the use of moving beds for adsorbent regeneration whereas moving beds are infeasible for ultra-low concentration streams because of bead-to-bead diffusion of contaminants.

The aforementioned processes do not address the problem of ultra-low concentration HAP streams and focus either on the adsorbent material or the method to add energy to the regeneration system. Thus, these systems universally suffer from constraints due to the method of regeneration or the use of a strongly adsorbing resin. To date, the only process which has been successfully applied to ultra-low concentration air streams is non-regenerable GAC. The need for a technology that removes HAPs from ultra-low concentration air streams in an efficient and economical manner has remained unfulfilled.

### BACKGROUND OF THE INVENTION—OBJECTS AND ADVANTAGES

Significant aspects of the invention are:
a) The ability to meet emission limits in the parts-per-billion range with a regenerative adsorption technology;
b) The application of regenerative adsorption technology to vapor streams with inlet VOC/HAP concentrations of 50 ppmv or less;
c) The ability to install a regenerative adsorption system in applications where only single-use adsorption systems were previously feasible and thus provide lower operating costs;
d) The use of synthetic adsorption beads which allow the process to take place at relatively low temperatures. These beads (which may or may not be hydrophobic) expand when heated to allow trapped VOCs to escape to atmosphere;
e) The addition of an adsorbent “pre-treatment” step whereas the synthetic adsorbent is cleaned thoroughly prior to being suitable for ultra-low concentration applications;
f) The ability of the desorption section to thoroughly clean the resin providing working capacity of 100 percent (measurable);
g) The characteristic of being highly turbulent in the desorption bed minimizing any bead-to-bead diffusion of HAPs;
h) The characteristic of maximizing jetting length in the regeneration bed to sweep HAPs away from the adsorbent media quickly;
i) The characteristic of having a high number of actual stages relative to the number of required theoretical stages in the desorption section;
j) The characteristic of having a adsorption bed distributor plate designed to minimizing jetting and thus maximize HAP adsorption;
k) The characteristic of adding a sacrificial adsorption bed to the destruction unit effluent to remove by-products that may form during oxidation of desorbed HAPs.
l) The characteristic of being relatively uniform in temperature across the regeneration bed; and
m) The characteristic of using multi-stage adsorption and regeneration stages to economically treat high inlet concentrations and achieve ultra-low emission limits.

### DRAWINGS—FIGURES

FIG. 1: GAC ADSORPTION ISOTHERM FOR TRICHLOROETHYLENE

FIG. 2: ADSORPTION MASS TRANSFER ZONE

FIG. 3: ADSORPTION BREAKTHROUGH RESULTS—GAC ADSORPTION BED AT ULTRA-LOW CONCENTRATIONS OPERATING IN HUMID AIR STREAM

FIG. 4: EFFECT OF HUMIDITY ON GAC AND DOW CHEMICAL'S V503 RESIN

FIG. 5: LABORATORY ADSORPTION APPARATUS

FIG. 6: LABORATORY DESORPTION APPARATUS

FIG. 7: TCE ADSORPTION ISOTHERM FOR V503 RESIN AT ULTRA-LOW CONCENTRATIONS

FIG. 8: ULTRA LOW CONCENTRATION STUDY RESULTS

FIG. 9: TCE CONCENTRATION PROFILE IN REGENERATION COLUMN AIR STREAM

FIG. 10: V503 RESIN PERFORMANCE FOR REPEATED REGENERATION CYCLES

FIG. 11: UNSPECIFIED POLYMERIC RESIN PERFORMANCE FOR REPEATED REGENERATION CYCLES (Y. COHEN, 1998)

FIG. 12: PREFERRED EMBODIMENT GENERALIZED LAYOUT AND P&ID

FIG. 13: PREFERRED EMBODIMENT GENERALIZED LAYOUT AND P&ID (CONTINUED)

FIG. 14: PREFERRED EMBODIMENT GENERALIZED LAYOUT AND P&ID (CONTINUED)

FIG. 15: PREFERRED EMBODIMENT GENERALIZED LAYOUT AND P&ID (CONTINUED)

FIG. 16: PREFERRED EMBODIMENT GENERALIZED LAYOUT AND P&ID (CONTINUED)

FIG. 17: PREFERRED EMBODIMENT GENERALIZED LAYOUT AND P&ID (CONTINUED)

FIG. 18: PREFERRED EMBODIMENT GENERALIZED LAYOUT AND P&ID (CONTINUED)

FIG. 19: ALTERNATIVE EMBODIMENT FOR RECOVERING LOW BOILING POINT COMPOUNDS

FIG. 20: ALTERNATIVE EMBODIMENT UTILIZING RECIRCULATING FLUIDIZED BED

FIG. 21: ALTERNATIVE EMBODIMENT FOR RECOVERY OF LIQUID SOLVENT

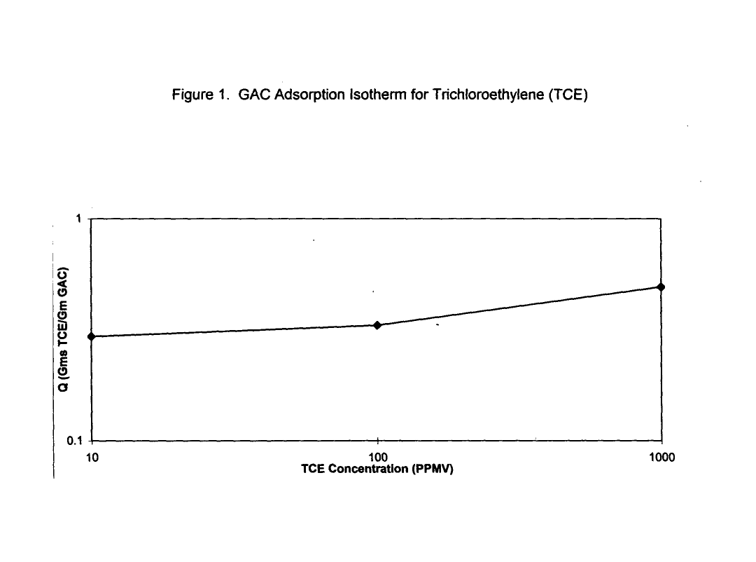

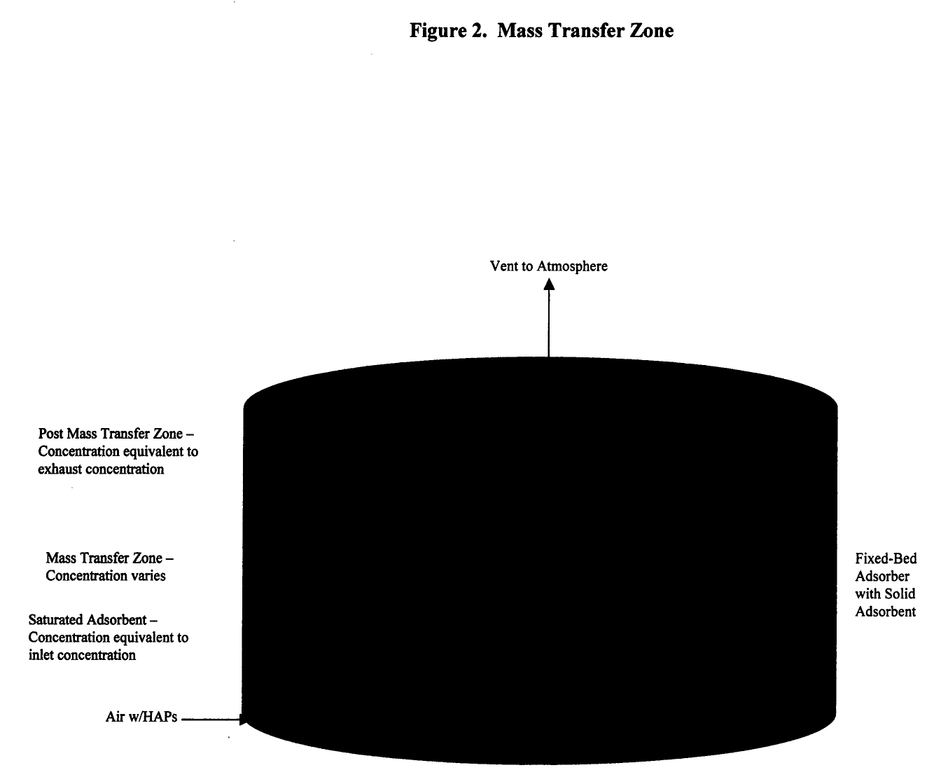

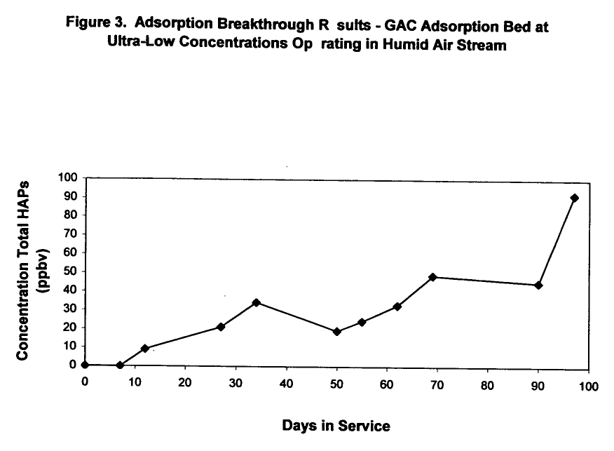

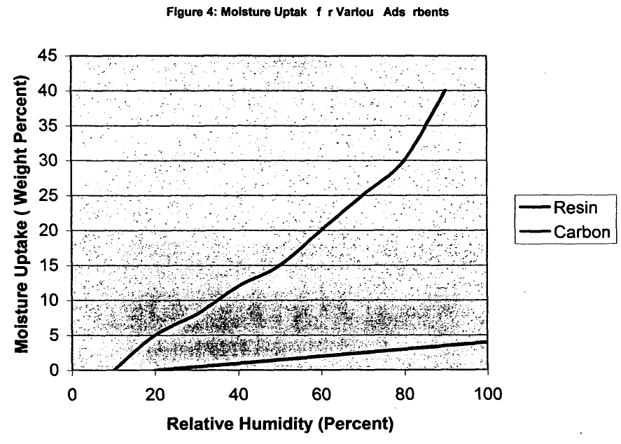

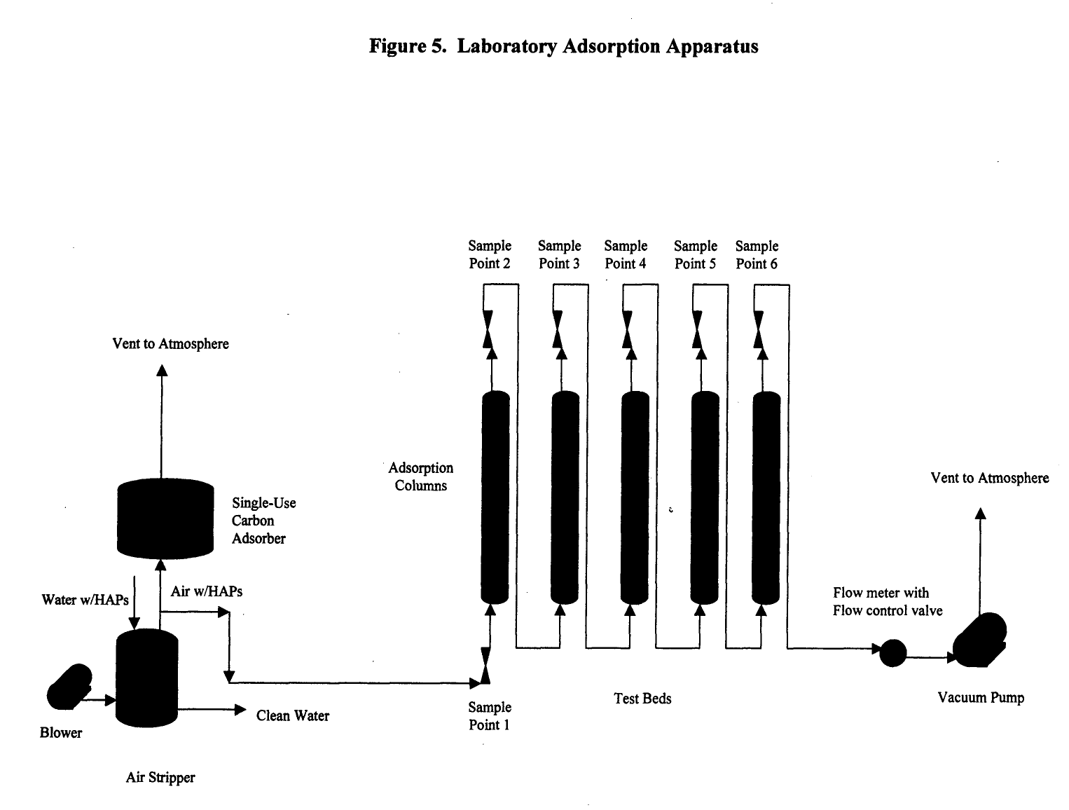

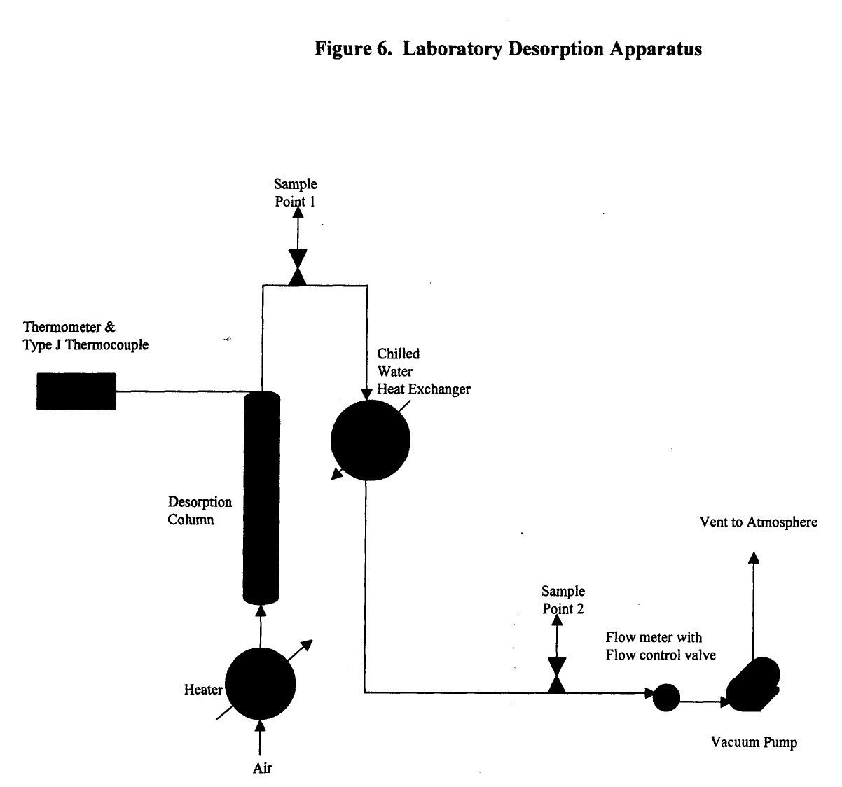

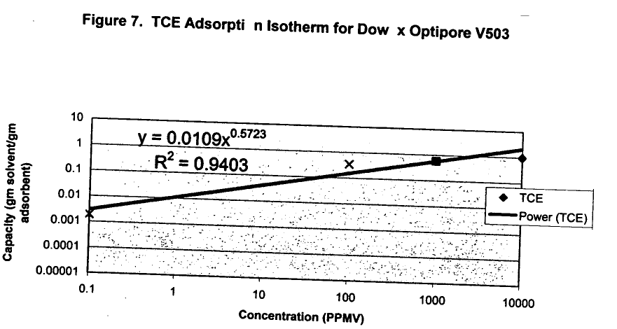

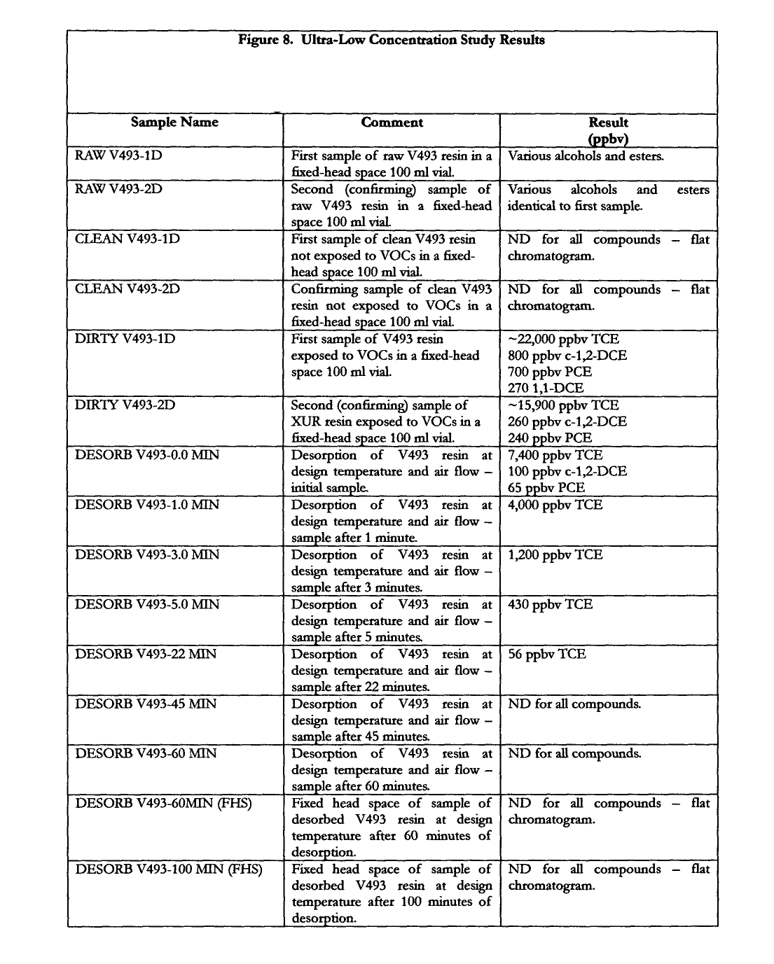

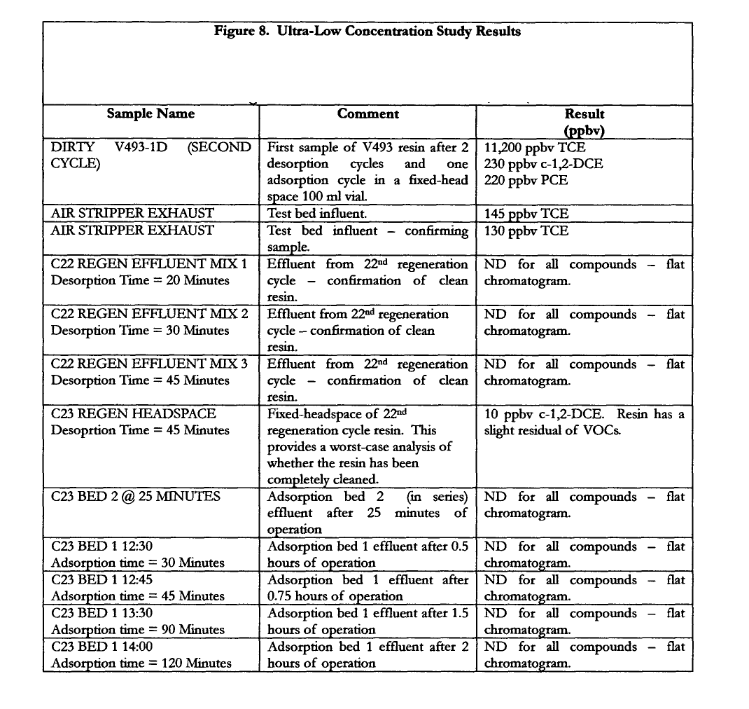

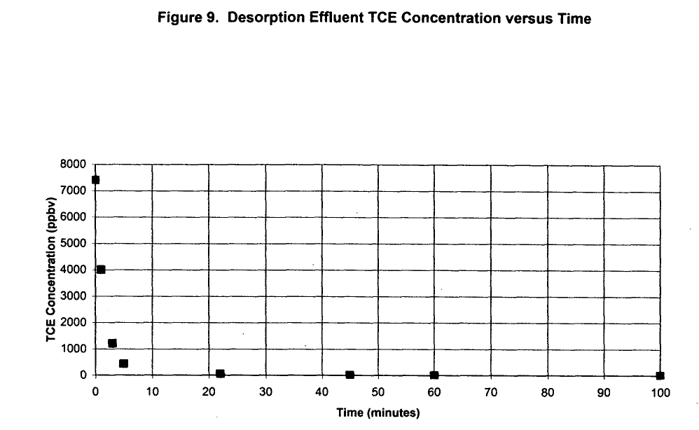

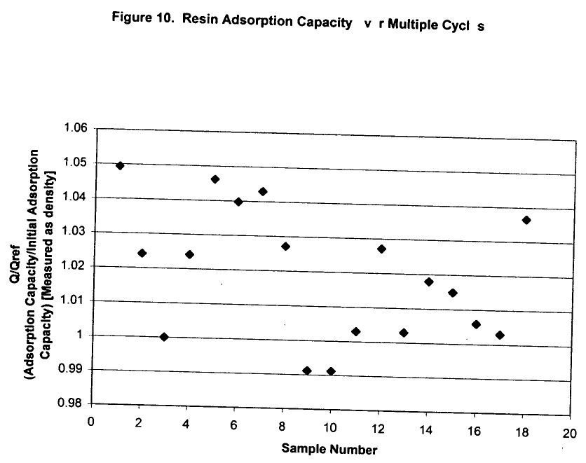

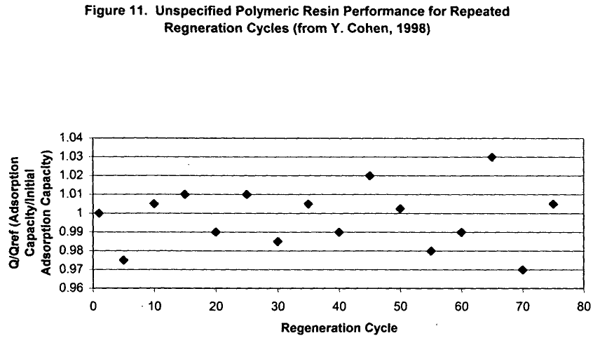

### DETAILED DESCRIPTION—PREFERRED EMBODIMENT

As used herein, HAP means hazardous air pollutant or volatile organic compound or toxic air contaminant These are generally assumed here to be chlorinated compounds but can be non-halogenated compounds that would not form acid gas when oxidized.

As used herein, adsorbent or resin means a synthetic polymeric adsorbent alone or in combination with a carbonaceous adsorbent.

As used herein, valve means a sliding gate valve or other appropriate valve.

The type of adsorbent appropriate for ultra-low emission control is exemplified by, but not limited to, The Dow Chemical Company's Dowex V493 or V503.

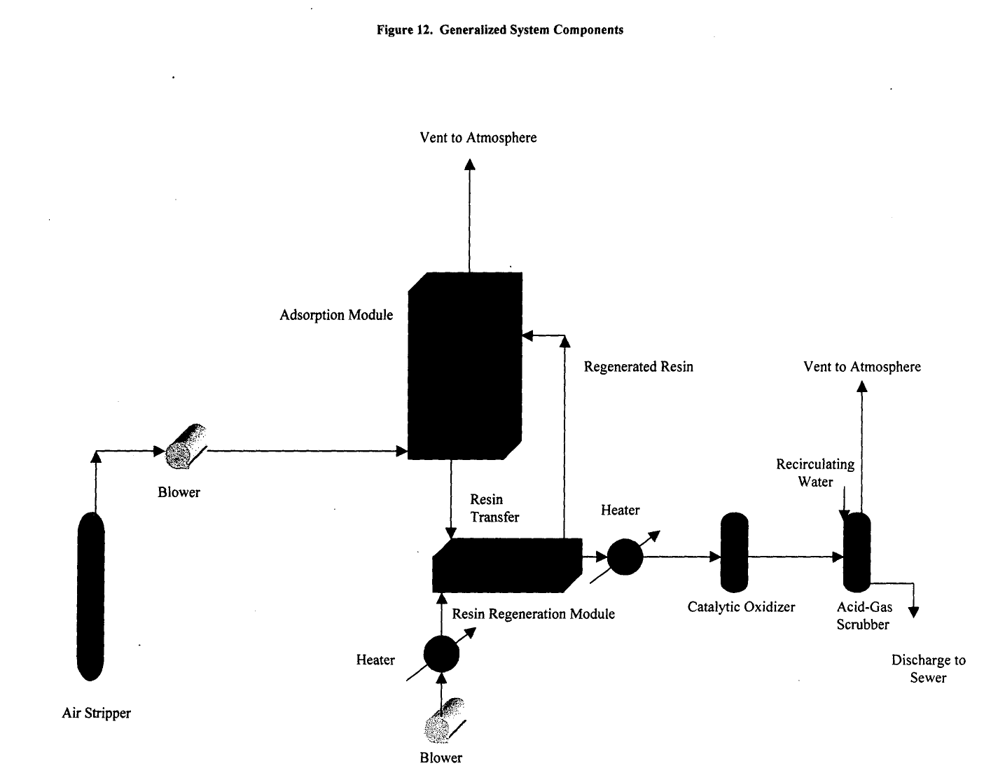

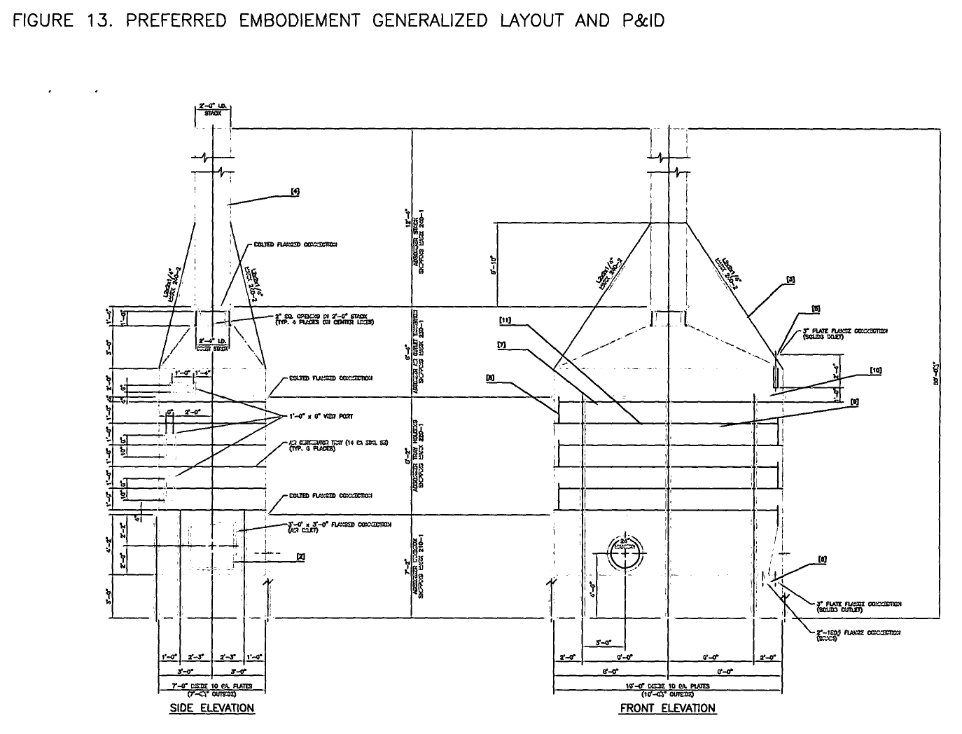

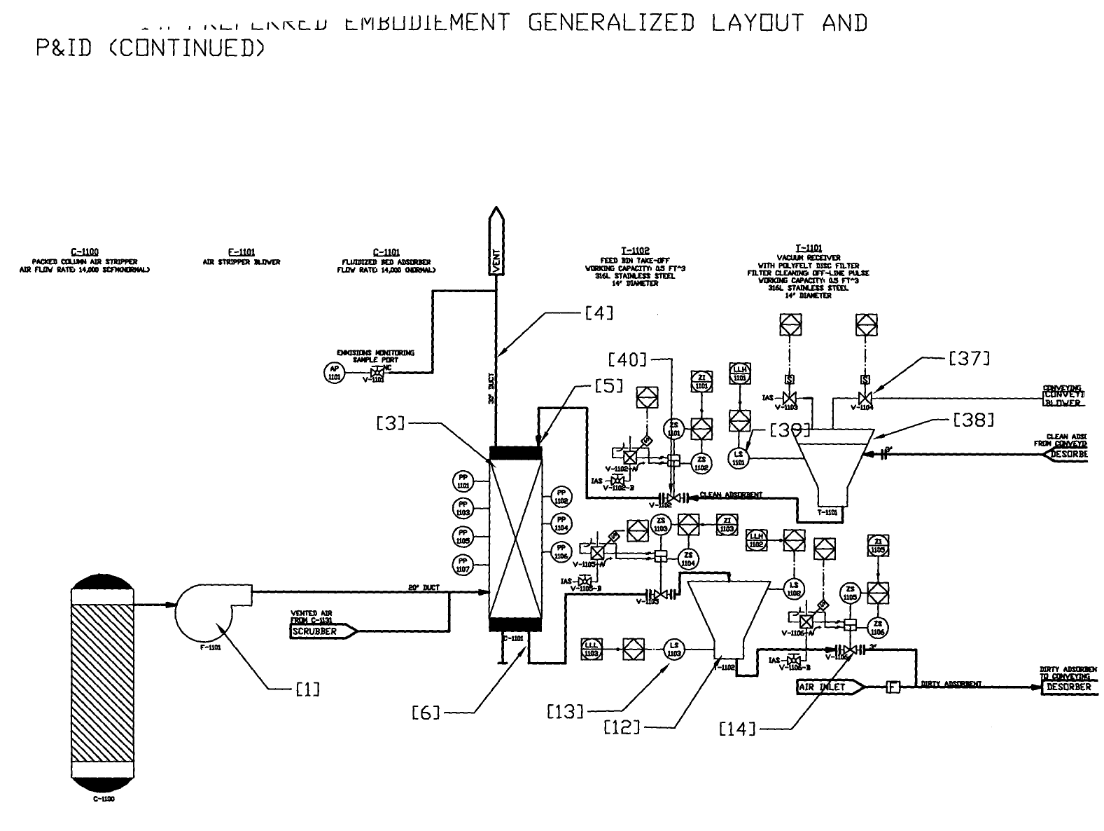

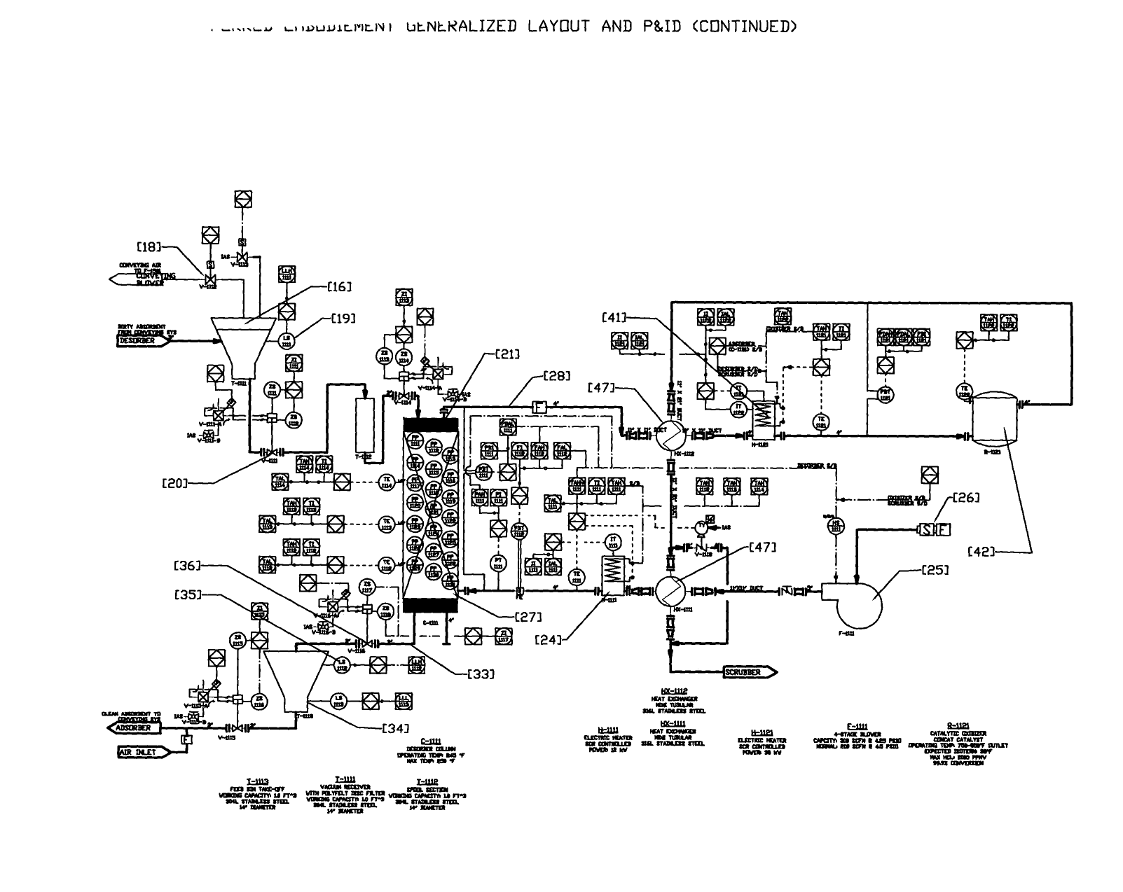

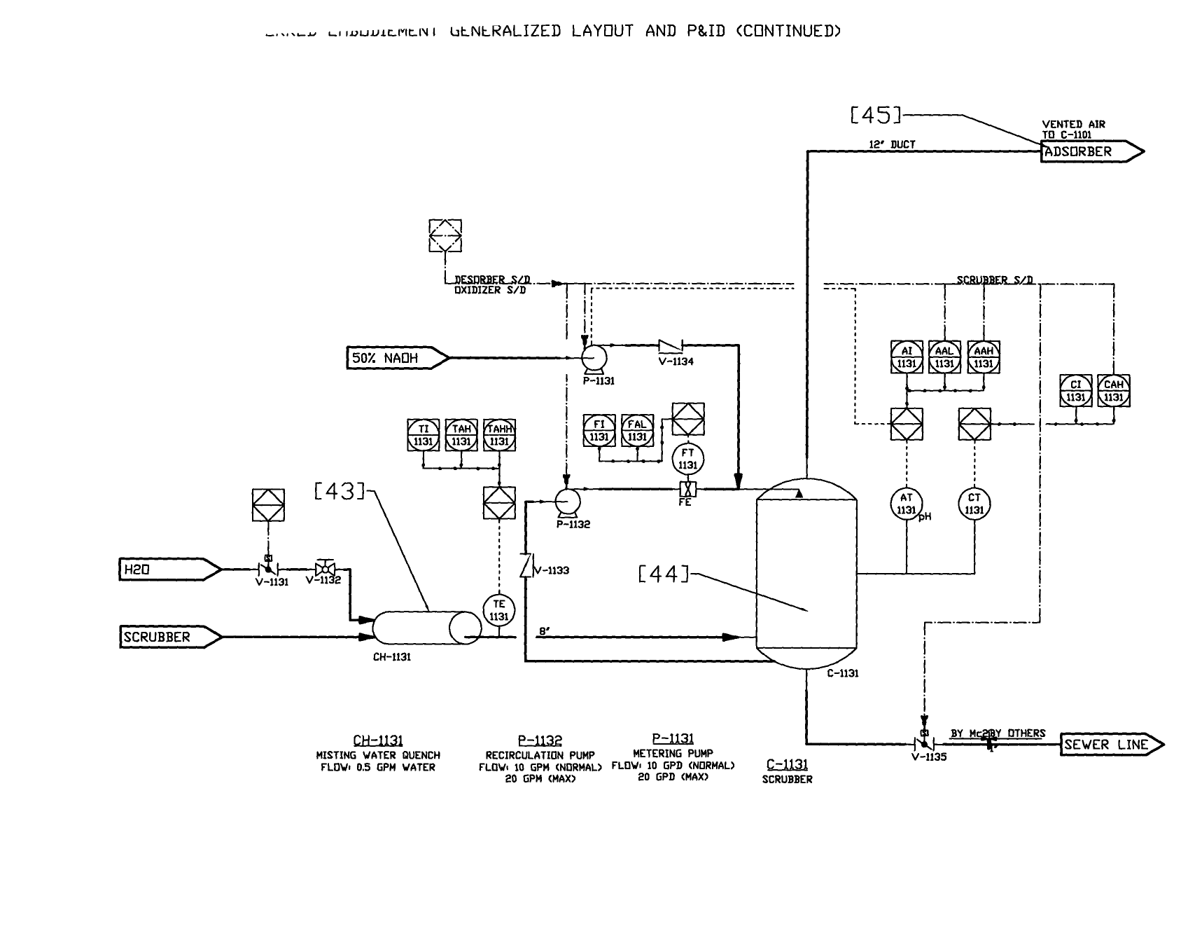

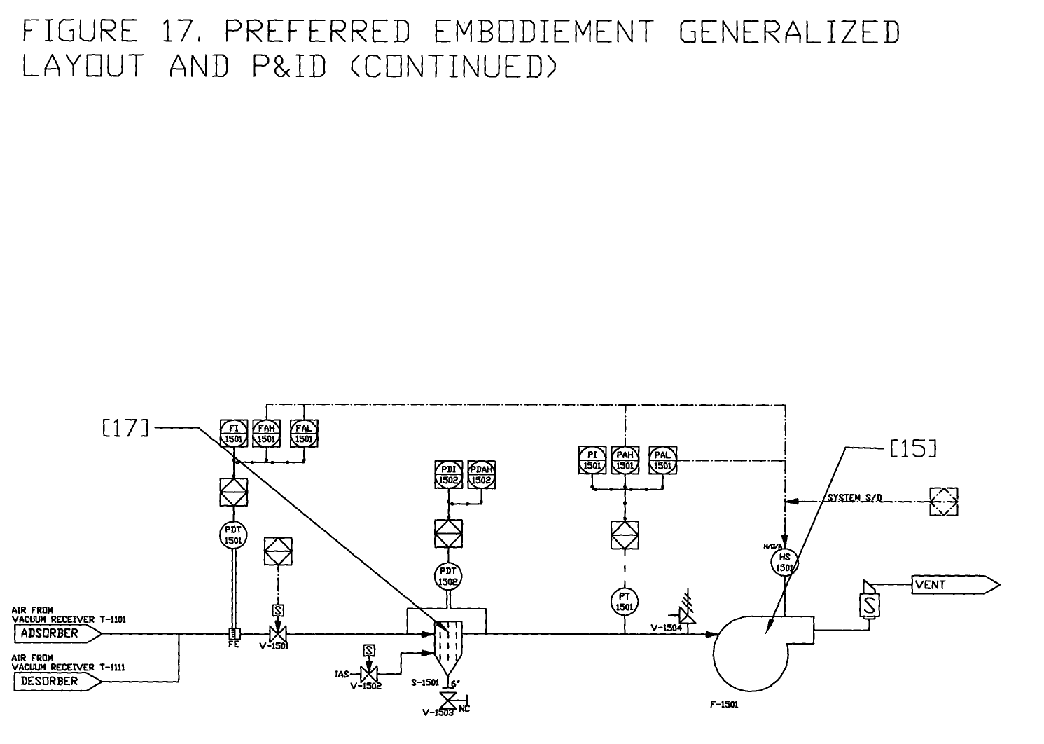

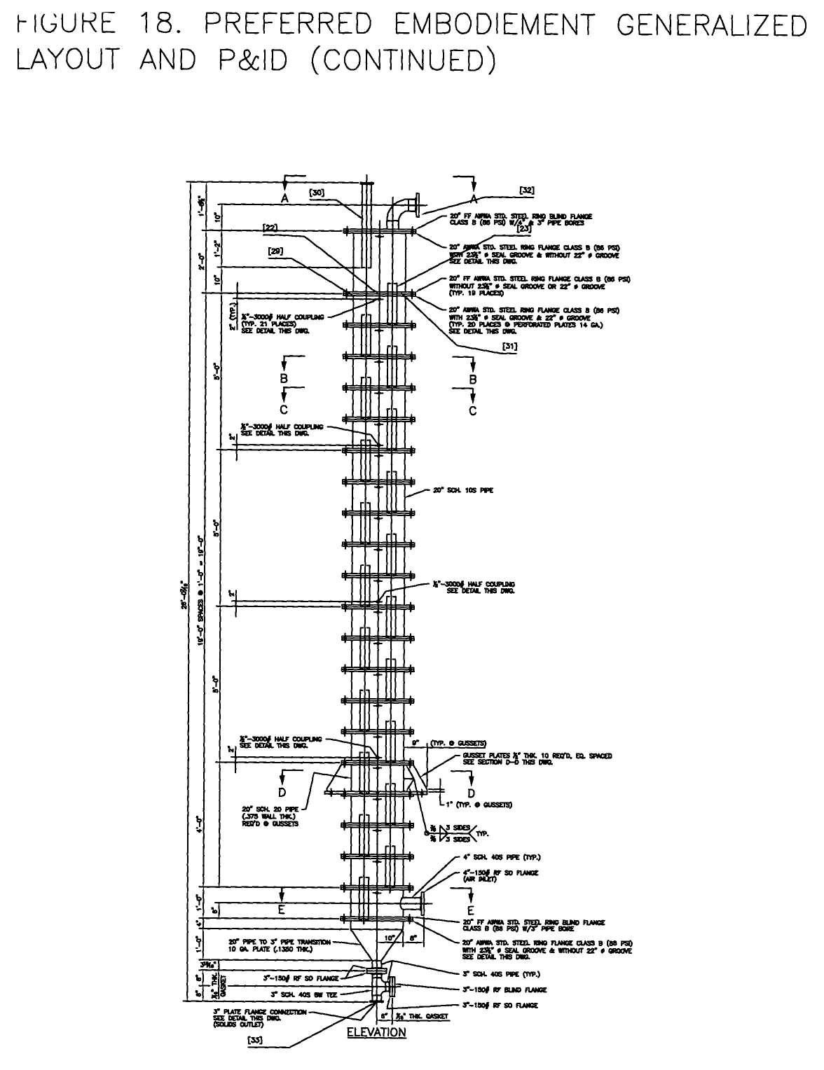

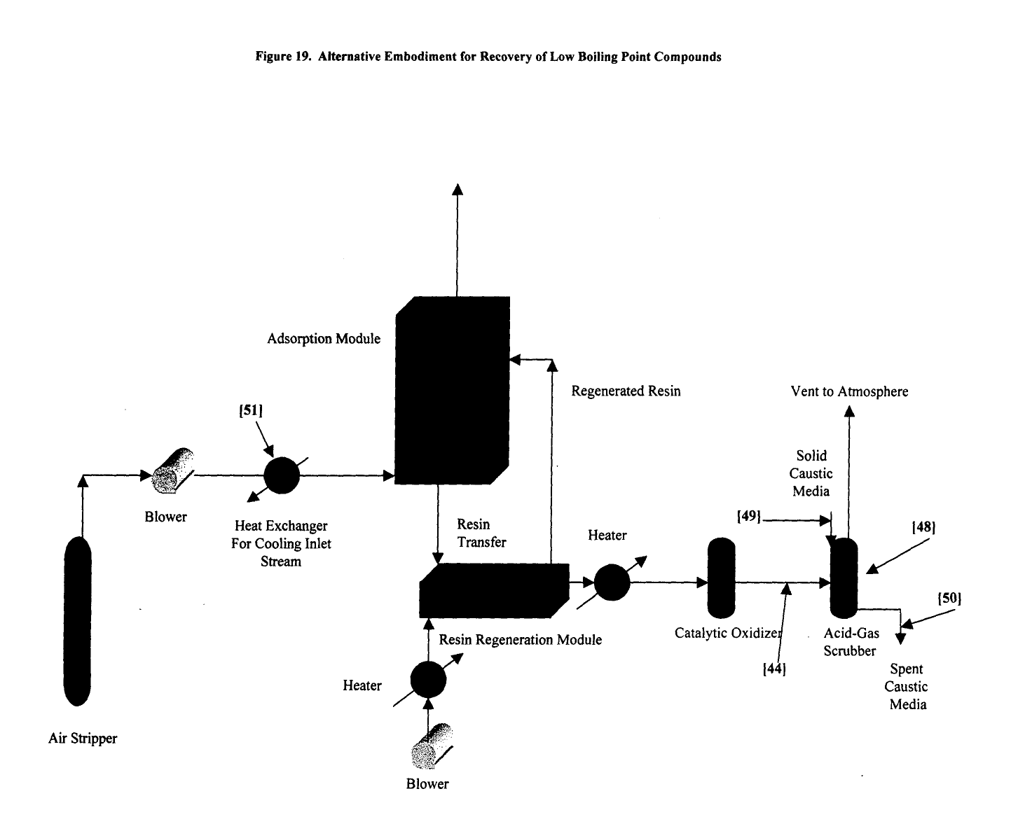

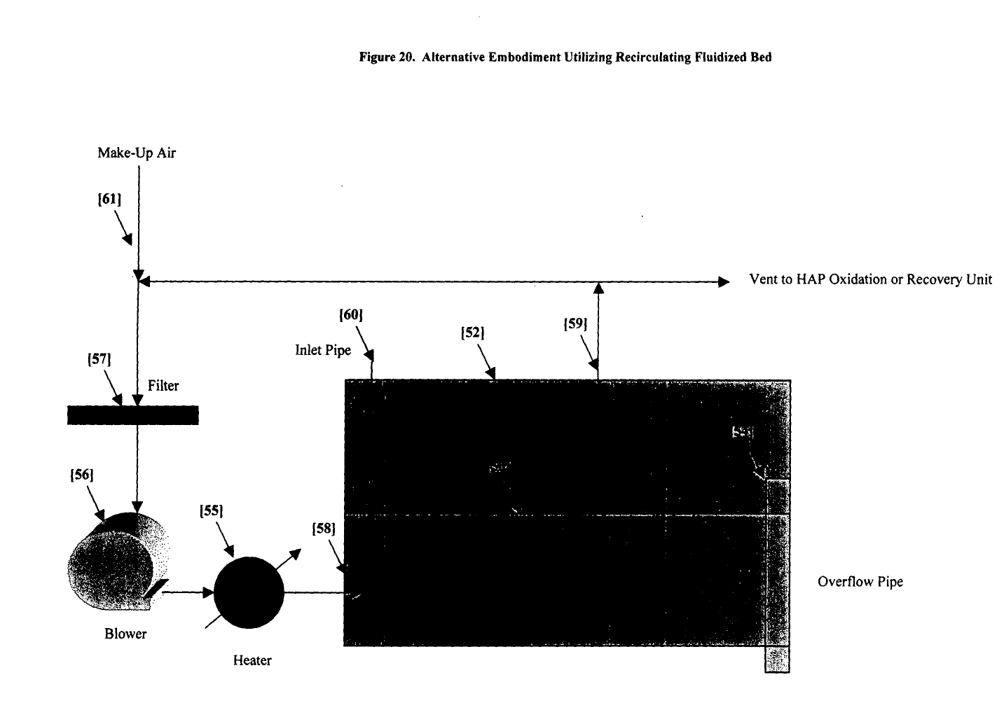

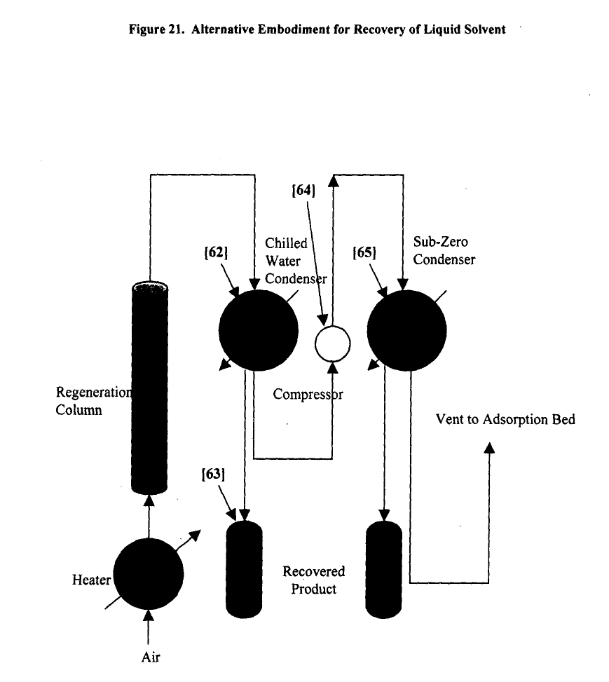

The general concept is described in FIG. 12 which incorporates a moving- or fluid-bed adsorber to remove HAPs from an air stream, a highly turbulent, multi-stage strongly fluidized bed desorption column to regenerate the adsorbent, an oxidizer and scrubber to desorb the evolved compounds, and a pneumatic transfer system to transfer adsorbent between the system components. The references below start on FIG. 13.

An air stripping blower [1] or other blower (such as soil vapor extraction or process air ventilation), conveys contaminated air at a constant rate into the inlet plenum [2] of the fluidized bed adsorber [3]. This adsorber can be any adsorber of standard design (e.g. a multi-tray counter-flow fluidized bed [3] or a cross-flow moving bed adsorber) as long as the adsorbent can be transferred in and out of the bed. Standard features of an adsorber design are the inlet plenum [2] and exhaust stack [4], and an adsorbent media inlet feed port [5] and outlet port [6].

The inlet air flows upward through the adsorbent trays and into a distributor plate [7]. The distributor plate design is critical to allow sufficient contact time for complete adsorption of the HAPs. The design must be such that bubbling in the bed is minimized. One embodiment of this design is to utilize a frited metal plate or to use a flow deflector. The distributor plate acts to distribute the air flow evenly across the entire tray [7]. The trays should be level and parallel with overflow weirs or pipes [8] to allow vertical flow of the resin downward [9] through the series of trays. Fresh resin enters at the top of the adsorber [10] and is distributed through fluidization in a roughly circular frontal pattern on the top tray. The resin then flows horizontally—like a fluid—until it encounters an overflow pipe or weir [8]. Once the resin encounters an overflow appertunance, it cascades downward to the next horizontal tray [11]. The motive force for movement of the resin is a combination of the energy added by the system blower providing for fluidization and the introduction of fresh adsorbent media causing physical displacement of existing resin.

The distributor design is well-established chemical and mechanical engineering theory and practice; however, it is critical in ultra-low VOC applications that the distributor tray openings be as small as feasible. This is due to jetting and the associated drop in adsorption efficiency when the jets are too long. Thus, in this application, the adsorption openings should be a maximum of 2.0 mm with spacing on the order of two times the opening and open area of 10 percent or less. The number of trays in the adsorber is a function of the required emission limit and the HAP being treated but can vary from 1 to 10 with 4 or 6 trays being the most common [3].

The HAP-laden air exits the top of the adsorber after passing through all of the trays [3]. The adsorbent exits the bottom of the adsorber through a feed pipe [6] after having cascaded down all of the trays into a hopper [12]. The hopper contains proximity switches [13] that signal the hopper is full or empty thus allowing for the balancing of input and output resin volumes. When the adsorber exit hopper is full, a pneumatic transfer system is triggered that consists of sliding gate valves [14], or their equivalent, a pneumatic transfer blower [15], a receiving hopper [16], and a fractured media filtering device [17]. The pneumatic blower activates causing suction to form on the exit of the adsorption hopper. The valve at the bottom of the adsorption hopper [14] opens and the valve [18] at the top of the receiving hopper [16] opens to direct the flow of adsorbent to the receiving hopper. The adsorbent enters the receiving hopper [16] and any fractured resin is captured in the media filtering device [17]. When the receiving hopper is full, the proximity switch triggers [19] and the valves close. The valve on the bottom receiving hopper opens [20] and the adsorbent is allowed to gravity feed into the regeneration column [21].

The regeneration column is a tall column with multiple trays [21]. Each tray consists of a distributor plate [22] and an overflow pipe [23]. The characteristics of the distributor tray are such that the fluidization in the desorber is extremely turbulent. Like the adsorber, the regeneration column has multiple trays of resin where the stripping gas flows upward and the adsorbent resin flows downward in a countercurrent fashion. The distributor design can be any feasible design; however, unlike the adsorber, the regeneration column distributor holes are relatively large so that the jet length is long. This long jet length is critical to carry desorbed contaminants away from the resin and to minimize bead-to-bead diffusion of the contaminants that prolongs the resin cleaning cycle. Moveover, the number of trays relative to the number of theoretical trays required needs to be approximately a multiple of 2 to 10 times. The column should be of sufficient diameter such that good concentration is achieved of 50 to 500 times the inlet air volume. This leads to high, narrow columns.

The regeneration column is heated [24] to reverse the physisorption of the HAPs on the adsorbent. Any heat method will suffice—electrical, gas fired, steam, microwaves, or hot oil—as long as the maximum column temperature is limited to prevent overheating of the adsorbent and subsequent damage to the adsorbent capacity. In the preferred embodiment, the regeneration column is at atmospheric pressure; however, the column can also be under vacuum. Placing the column under vacuum has the added benefit of enhancing diffusion from the bead but there is a corresponding loss of fluidization that must be made up for with additional flow and corresponding complications in the equipment design.

The regeneration column blower [25] drives air into the column. While the preferred embodiment uses air, an inert gas can be used particularly if higher regeneration temperatures are desired. The inlet air is filtered [26] to prevent damage to the blower and the exhaust to the blower is directed through an electrical heater [24], or other suitable heat source. The inlet air enters the inlet plenum [27] at the bottom of the column. The inlet air for the regeneration column flows upward through the column trays [22] and exhausts at the top of the column [28] laden with VOCs. The column distributor plates can be of a variety of designs but for simplicity is assumed to be a simple perforated plate. The distributor plate [29] acts to distribute the air flow evenly across the entire tray. The trays should be level and parallel with overflow weirs or pipes [23] to allow vertical flow of the resin downward through the series of trays. Contaminated resin enters at the top of the column [30] and is distributed through fluidization. Since the column trays are much smaller than the adsorber trays, the resin is distributed through turbulent mixing on the top tray and subsequent trays. The resin then flows—like a fluid—until it encounters an overflow pipe [23]. While other overflow devices can be used, the small size of the regeneration column makes other devices cumbersome. Once the resin encounters an overflow appearance, it cascades downward to the next horizontal tray [31]. The motive force for movement of the resin is again a combination of the energy added by the system blower providing for fluidization and the introduction of fresh adsorbent media causing physical displacement of existing resin.

The hot inlet air acts to heat the adsorbent media and the adsorbed HAPs. The HAPs then diffuse into the passing air stream and are carried away to the exit of the column [29]. When the adsorbent is heated, the pores expand allowing adsorbed HAPs that would otherwise not desorb to evolve into the passing air stream. This characteristic is critical when treating ultra-low concentration air streams because the micro-pores of the adsorbent which would normally become permanent adsorption sites, are regenerated. The key to regeneration are maintaining a steady equilibrium concentration gradient to drive HAPs from the adsorbent, extreme turbulence to minimize bead-to-bead diffusion and drive HAPs into the passing air stream and not onto nearby adsorbent beads, and allowing for sufficient time to drive HAPs from the center of the adsorbent beads to provide for a high working capacity in the adsorbent.

The HAP-laden air exits the top of the regeneration column after passing through all of the trays [32]. The HAP laden air has a higher concentration of HAPs proportional to the ratio of the adsorber inlet blower volume to the regeneration column volume. This is referred to as the concentration or turn-down ratio. The cleaned adsorbent exits the bottom of the regeneration column through a feed pipe [33] after having cascaded down all of the trays into a hopper [34]. The hopper contains proximity switches [35] that signal the hopper is full or empty thus allowing for the balancing of input and output resin volumes. When the regeneration column exit hopper is full, a pneumatic transfer system is triggers the pneumatic transfer system. The pneumatic blower activates causing suction to form on the exit of the regeneration column hopper. The valve at the bottom of the regeneration column exit hopper [36] opens and the valve [37] at the top of the adsorption column receiving hopper [38] opens to direct the flow of adsorbent to the receiving hopper. The adsorbent enters the receiving hopper [38] and any fractured resin is captured in the media filtering device [17]. When the receiving hopper is full, the proximity switch triggers [39] and the valves dose. The valve on the bottom receiving hopper opens [40] and the adsorbent is allowed to gravity feed back into the adsorption bed [3].

The resin is then cooled in the top tray of the adsorber. As an option, this can occur in a separate cooling bed. The media needs to cool before sufficient adsorption capacity is available to treat the VOC laden air stream entering the adsorber.

The HAP-laden air that exits the top of the regeneration column can be treated in a variety of ways. In the preferred embodiment, the air is heated further through an electrical heat source [41] and then passed through a catalytic oxidizer [42]. Alternative embodiments can use a different heat source and a different destruction methodology such as a thermal oxidizer or can cool and compress the gas for HAP recovery. The oxidized air stream is laden with acid gas from destruction of the halogenated compounds and is quenched [43] and scrubbed [44] with a caustic liquid to neutralize acid. The treated air can then be exhausted to atmosphere [45] through the system exhaust stack [4].

### DETAILED DESCRIPTION—ALTERNATIVE EMBODIMENTS

An alternative embodiment cools the HAP-laden air that exits the top of the regeneration column and adsorbs the HAPs onto a synthetic or other suitable adsorbent. The adsorbent can then be desorbed in a similar fashion and the resultant regenerated HAP stream can be compressed and condensed to recover VOCs.

An alternative embodiment utilizes heat recovery on the regeneration column to optimize operating economics [46]. In this embodiment, the regeneration air is heated prior to oxidation with a heat exchanger [46] that recovers heat from the oxidizer exhaust. The air is then heated [27] with a heater that can be fired by any means and oxidized. The air is then exhausted through the referenced heat exchanger [46]. An additional step would then recover further heat from the gas by exhausting it through another heat exchanger [47] that is used to preheat incoming regeneration air.

An alternative embodiment utilizes a basic (caustic) solid-media for neutralizing the acidic regeneration gas [44]. In this embodiment, the exhaust air from the oxidizer is fed through a bed of caustic solid media [48]. The solid media absorbs and neutralizes the acid gas. The solid media is periodically replenished either through an automated feed [49] and discharge [50] system or by swapping the adsorbent bed.

An alternative embodiment utilizes adsorption bed cooling to maximize the adsorption of low boiling point HAPs such as methylene chloride or freons [51]. This bed cooling would most commonly be accomplished through a traditional heat exchanger [51]. In this embodiment, the heat exchanger is cooled with either a standard water cooling tower or a brine chiller.

An alternative embodiment utilizes an inert or oxygen-depleted gas for regenerating the adsorbent to allow for higher regeneration temperatures without oxidizing (damaging) the adsorbent. In this embodiment, the regeneration column is a tall column with multiple trays as described above; however, the regeneration gas is either inert or oxygen-depleted. This can be accomplished in a variety of ways such as utilizing waste flue gas from other combustion processes or through the use of an inert gas generator such as a membrane to produce nitrogen. This embodiment has significant advantages to speed recovery of higher boiling point compounds such as pyrenes. Pyrenes can have a very long desorption time of up to two hours. If the recovery is faster, the resin is placed back into service faster and the amount of resin in the overall system can be reduced, making the system more economical.

An alternative embodiment utilizes a recirculating fluidized bed for regeneration of the adsorbent [52]. The recirculating fluidized bed has a single tray. The tray utilizes a distributor tray with large distributor openings so that the jet length is long. Again, the long jet length is critical to carry desorbed contaminants away from the resin and to minimize bead-to-bead diffusion of HAPs that prolong the cleaning cycle. The recirculating bed must be sized so that the overall bed volume is small to maximize fresh air turnover. The main advantages of a recirculating bed is it that it is simple to manufacture and is relatively small when compared to the referenced regeneration column. The recirculating bed must be large enough to provide the residence time necessary for complete desorption of the resin and the temperature must be high enough such that the concentrated air stream is above it's HAP-adsorbent equilibrium point.

In this alternative, the recirculating bed consists of a single tray. The tray consists of a distributor plate [53] and an overflow pipe or weir [54]. The distributor plate acts to distribute the air flow evenly across the entire tray. The overflow pipe or weir acts to remove dean adsorbent from the bed for cooling and reuse in the adsorbent bed. The characteristics of the distributor tray are such that the fluidization in the desorber is extremely turbulent. The stripping gas flows upward and the adsorbent resin flows across the bed in a crosscurrent fashion. The recirculating bed is heated [55] to reverse the physisorption of the HAPs on the adsorbent. Any heat method will suffice—electrical, gas fired, steam, microwaves, or hot oil—as long as the maximum bed temperature is limited to prevent overheating of the adsorbent and subsequent damage to the adsorbent capacity. In the preferred embodiment, the recirculating bed is at atmospheric pressure; however, the bed can also be under vacuum. Placing the bed under vacuum has the added benefit of enhancing diffusion from the bead but there is a corresponding loss of fluidization that must be made up for with additional flow and corresponding complications in the equipment design.

The recirculating bed blower [56] drives air into the bed [52]. While the preferred embodiment uses air, an inert gas can be used particularly if higher regeneration temperatures are desired. The inlet air is filtered [57] to prevent damage to the blower and the exhaust of the blower is directed through an electrical heater [55], or other suitable heat source, that controls the temperature to the desired set point. Alternatively, the media can be heated directly using a microwave generator. The inlet air enters the inlet plenum [58] at the bottom of the bed. The inlet air for the recirculating bed flows upward through the single tray [53] and exhausts at the top of the bed [59] laden with VOCs. A steady stream of air drawn off the bed for either destruction or recovery of the HAPs as described above. The air is drawn down toward the inlet of the recirculation fan and make-up air is introduced into the air stream. The air stream then recirculates through the blower [56].

Contaminated resin enters at the top of the regeneration bed [60] and is distributed through fluidization and turbulent mixing. The resin then flows—like a fluid—until it encounters an overflow pipe or weir [54]. Once the resin encounters an overflow appertunance, it cascades downward to a staging hopper as described in the preferred embodiment. The motive force for movement of the resin is again a combination of the energy added by the system blower providing for fluidization and the introduction of fresh adsorbent media causing physical displacement of existing resin.

The hot regeneration air acts to heat the adsorbent media and the adsorbed HAPs. The HAPs then diffuse into the passing air stream and are carried away to the exit of the regeneration bed [59]. When the adsorbent is heated, the pores expand allowing adsorbed HAPs that would otherwise not desorb to evolve into the passing air stream. This characteristic is critical when treating ultra-low concentration air streams because the micro-pores of the adsorbent which would normally become permanent adsorption sites, are regenerated. The key to making this embodiment work is the small size of the unit relative to the make-up air stream [61]. This high volume ratio ensures that HAP concentrations in the recirculating bed stay lower than the gas-solid equilibrium point. The considerations bed turbulence to minimize bead-to-bead diffusion and drive HAPs into the passing air stream and not onto nearby adsorbent beads, and allowing for sufficient time to drive HAPs from the center of the adsorbent beads to provide for a high working capacity in the adsorbent are important in both the recirculating bed and the column embodiments.

The HAP-laden air exits the top of the recirculating bed [59]. The HAP laden air has a higher concentration of HAPs proportional to the ratio of the adsorber inlet blower volume to the regeneration column volume. This is referred to as the concentration or turn-down ratio. The cleaned adsorbent exits the bottom of the recirculating bed through a the overflow weir or pipe [54] after having flowed across the tray into a hopper [34]. The hopper contains proximity switches [35] that signal the hopper is full or empty thus allowing for the balancing of input and output resin volumes. When the recirculation bed exit hopper is full, a pneumatic transfer system is triggers the pneumatic transfer system. The pneumatic blower activates causing suction to form on the exit of the regeneration column hopper. The valve at the bottom of the recirculation bed exit hopper [36] opens and the valve [37] at the top of the adsorption column receiving hopper [38] opens to direct the flow of adsorbent to the receiving hopper. The adsorbent enters the receiving hopper [38] and any fractured resin is captured in the media filtering device [17]. When the receiving hopper is full, the proximity switch triggers [39] and the valves close. The valve on the bottom receiving hopper opens [40] and the adsorbent is allowed to gravity feed back into the adsorption bed [1].

The resin is then cooled in the top tray of the adsorber. As an option, this can occur in a separate cooling bed. The media needs to cool before sufficient adsorption capacity is available to treat the VOC laden air stream entering the adsorber.

The HAP-laden air that exits the top of the recirculating bed can be treated as discussed above. An alternative embodiment cools the HAP-laden air that exits the top of the regeneration column and adsorbs the HAPs onto a synthetic or other suitable adsorbent. The adsorbent can then be desorbed in a similar fashion and the resultant regenerated HAP stream can be compressed and condensed to recover VOCs. An alternative embodiment utilizes heat recovery on the regeneration column to optimize operating economics. An alternative embodiment utilizes adsorption bed cooling to maximize the adsorption of low boiling point HAPs such as methylene chloride or freons.

An alternative embodiment recovers HAPs as liquids or gas for reuse or off-site disposal or recycling. In this embodiment, the HAP-laden air exits the top of the recirculating bed or regeneration column. The HAP-laden air is then cooled through the use of a heat exchanger [62]. Any liquid that condenses is captured in a container that is isolated from the passing air stream to minimize evaporation [63]. The air stream can be cooled in multiple steps to effect different solvent recoveries or the air stream can be cooled [62], compressed [64], and cooled again [65] in a standard fashion for recovery of solvents. The air stream could also be treated with a different separation technology such as a membrane or molecular sieve.

1. A process for treating HAPs in air to ultra-low emission limits, said process to include the steps of:
a. Passing the air stream through a bed of synthetic adsorbent,
b. Removing the adsorbent to a regeneration column;
c. Regenerating the adsorbent at elevated temperature and above-atmospheric pressure in a highly turbulent fluidized bed operating as an equilibrium-stage column;
d. Cooling of the adsorbent;
e. Placement of the adsorbent back into the adsorption bed;
f. Destruction of the HAP vapors using a catalytic oxidizer,
g. Scrubbing of the vapors with a caustic scrubber or solid basic adsorbent to remove acid gas; and
h. Exhausting the regeneration air stream to the atmosphere.

2. A process according to claim 1, wherein the adsorbent is also hydrophobic.

3. A process according to claim 1, wherein the HAP vapors are destroyed in a thermal oxidizer.

4. A process according to claim 1, wherein the HAP vapors are destroyed in a UV/Oxidation system.

5. A process according to claim 1, wherein the scrubbed vapors are exhausted into the adsorption bed to remove combustion by-products.

6. A process according to claim 1, wherein the regeneration column is placed under vacuum to reduce the temperature required for regeneration.

7. A process according to claim 1, wherein heat recovery is used to minimize operating costs.

8. A process according to claim 1, wherein the inlet air stream is cooled to maximize adsorption of HAPs or low-boiling point compounds.

9. A process according to claim 1, wherein the desorbed HAP vapors are adsorbed onto another adsorbent bed.

10. A process according to claim 1, wherein the adsorption bed and regeneration bed are the same device.

11. A process according to claim 1, wherein the HAP vapors are recovered in liquid or gaseous form for recycling, reuse, or off-site disposal.

12. A process according to claim 1, wherein the regeneration column is heated with a microwave generator,

13. Any combination of claims 1 through 12.

14. A process for treating HAPs in air to ultra-low emission limits, said process to include the steps of:
a. Passing the air stream through a bed of synthetic adsorbent,
b. Removing the adsorbent to a regeneration column;
c. Regenerating the adsorbent at elevated temperature and above-atmospheric pressure in a highly turbulent fluidized bed operating as an equilibrium-stage column;
d. Utilizing an inert gas or a gas with decreased oxygen levels to effect the regeneration to allow for higher temperature in the regeneration column and/or to effect regeneration of higher boiling point compounds without oxidizing the adsorbent,
e. Cooling of the adsorbent;
f. Placement of the adsorbent back into the adsorption bed;
g. Cooling of the desorbed HAP vapors;
h. Adsorption of the HAP vapors using an adsorbent bed; and
i. Exhausting the regeneration air stream to the atmosphere.

15. A process according to claim 14, wherein the adsorbent is also hydrophobic.

16. A process according to claim 14, wherein oxygen content of the regeneration gas is monitored and/or controlled to allow for higher temperature in the regeneration column and/or to effect regeneration of higher boiling point compounds without oxidizing the adsorbent;

17. A process according to claim 14, wherein oxygen is reintroduced in the HAP vapor stream and the vapors are destroyed in a catalytic oxidizer and the vapors are scrubbed using a caustic scrubber or solid basic adsorbent.

18. A process according to claim 14, wherein oxygen is reintroduced in the HAP vapor stream and the vapors are destroyed in a thermal oxidizer and the vapors are scrubbed using a caustic scrubber or solid basic adsorbent.

19. A process according to claim 14, wherein oxygen is reintroduced in the HAP vapor stream and the vapors are destroyed in a UV/Oxidation system and the vapors are scrubbed using a caustic scrubber or solid basic adsorbent.

20. A process according to claim 14, wherein the HAP vapors are destroyed in a UV/Oxidation system.

21. A process according to claim 14, wherein the scrubbed vapors are exhausted into the adsorption bed to remove combustion by-products.

22. A process according to claim 14, wherein the regeneration column is placed under vacuum to reduce the temperature required for regeneration.

23. A process according to claim 14, wherein heat recovery is used to minimize operating costs.

24. A process according to claim 14, wherein the inlet air stream is cooled to maximize adsorption of HAPs or low-boiling point compounds.

25. A process according to claim 14, wherein the adsorption bed and regeneration bed are the same device.

26. A process according to claim 14, wherein the HAP vapors are recovered in liquid or gaseous form for recycling, reuse, or off-site disposal;

27. A process according to claim 14, wherein the regeneration column is heated with a microwave generator.

28. Any combination of claims 14 through 27.

29. A process for treating HAPs in air to ultra-low emission limits, said process to include the steps of:
a. Passing the air stream through a bed of synthetic adsorbent;
b. Removing the adsorbent to a regeneration bed;
c. Regenerating the adsorbent at elevated temperature and above-atmospheric pressure in a highly turbulent recirculating fluidized bed;
d. Cooling of the adsorbent;
e. Placement of the adsorbent back into the adsorption bed;
f. Destruction of the HAP vapors using a catalytic oxidizer,
g. Scrubbing of the vapors with a caustic scrubber or solid basic adsorbent to remove acid gas; and
h. Exhausting the regeneration air stream to the atmosphere.

30. A process according to claim 29, wherein the adsorbent is also hydrophobic.

31. A process according to claim 29, wherein the HAP vapors are destroyed in a thermal oxidizer.

32. A process according to claim 29, wherein the HAP vapors are destroyed in a UV/Oxidation system.

33. A process according to claim 29, wherein the scrubbed vapors are exhausted into the adsorption bed to remove combustion by-products.

34. A process according to claim 29, wherein the regeneration bed is placed under vacuum to reduce the temperature required for regeneration.

35. A process according to claim 29, wherein heat recovery is used to minimize operating costs.

36. A process according to claim 29, wherein the inlet air stream is cooled to maximize adsorption of HAPs or low-boiling point compounds.

37. A process according to claim 29, wherein the desorbed HAP vapors are adsorbed onto another adsorbent bed.

38. A process according to claim 29, wherein the adsorption bed and regeneration bed are the same device.

39. A process according to claim 29, wherein the HAP vapors are recovered in liquid or gaseous form for recycling, reuse, or off-site disposal;

40. A process according to claim 29, wherein the regeneration column is heated with a microwave generator.

41. Any combination of claims 29 through 40.

42. A process for treating HAPs in air to ultra-low emission limits, said process to include the steps of:
a. Passing the air stream through a bed of synthetic adsorbent;
b. Removing the adsorbent to a regeneration bed;
c. Regenerating the adsorbent at elevated temperature and above-atmospheric pressure in a highly turbulent recirculating fluidized bed;
d. Utilizing an inert gas or a gas with decreased oxygen levels to effect the regeneration to allow for higher temperature in the regeneration column and/or to effect regeneration of higher boiling point compounds without oxidizing the adsorbent;
e. Cooling of the adsorbent;
f. Placement of the adsorbent back into the adsorption bed;
g. Cooling of the desorbed HAP vapors;
h. Adsorption of the HAP vapors using an adsorbent bed; and
i. Exhausting the regeneration air stream to the atmosphere.

43. A process according to claim 42, wherein the adsorbent is also hydrophobic.

44. A process according to claim 42, wherein oxygen content of the regeneration gas is monitored and/or controlled to allow for higher temperature in the regeneration column and/or to effect regeneration of higher boiling point compounds without oxidizing the adsorbent;

45. A process according to claim 42, wherein oxygen is reintroduced in the HAP vapor stream and the vapors are destroyed in a catalytic oxidizer and the vapors are scrubbed using a caustic scrubber or solid basic adsorbent.

46. A process according to claim 42, wherein oxygen is reintroduced in the HAP vapor stream and the vapors are destroyed in a thermal oxidizer and the vapors are scrubbed using a caustic scrubber or solid basic adsorbent.

47. A process according to claim 42, wherein oxygen is reintroduced in the HAP vapor stream and the vapors are destroyed in a UV/Oxidation system and the vapors are scrubbed using a caustic scrubber or solid basic adsorbent.

48. A process according to claim 42, wherein the HAP vapors are destroyed in a UV/Oxidation system.

49. A process according to claim 42, wherein the scrubbed vapors are exhausted into the adsorption bed to remove combustion by-products.

50. A process according to claim 42, wherein the regeneration column is placed under vacuum to reduce the temperature required for regeneration.

51. A process according to claim 42, wherein heat recovery is used to minimize operating costs.

52. A process according to claim 42, wherein the inlet air stream is cooled to maximize adsorption of HAPs or low-boiling point compounds.

53. A process according to claim 42, wherein the adsorption bed and regeneration bed are the same device.

54. A process according to claim 42, wherein the HAP vapors are recovered in liquid or gaseous form for recycling, reuse, or off-site disposal;

55. A process according to claim 42, wherein the regeneration column is heated with a microwave generator.

56. Any combination of claims 42 through 55.
